(19) United States
(12) Patent Application Publication
(10) Pub. No.: US 2024/0424566 A1
(43) Pub. Date: Dec. 26, 2024

(54) CABLE CARRIER FOR ADDITIVE MANUFACTURING SYSTEM

(71) Applicant: VulcanForms Inc., Burlington, MA (US)

(72) Inventors: Raghav Aggarwal, Somerville, MA (US); Chi M. Chan, Worcester, MA (US); Christopher L. Kennedy, Cambridge, MA (US)

(73) Assignee: VulcanForms Inc., Burlington, MA (US)

(21) Appl. No.: 18/746,535

(22) Filed: Jun. 18, 2024

Related U.S. Application Data
(60) Provisional application No. 63/509,907, filed on Jun. 23, 2023.

(51) Int. Cl. B22F 12/00; B33Y 30/00

(52) U.S. Cl. CPC B22F 12/00; B33Y 30/00

(57) ABSTRACT

Systems and methods for supporting a plurality of cables of an additive manufacturing system. A cable carrier having first and second ends may be configured to support the plurality of cables within a channel of the cable carrier. The cable carrier may be pivotably supported via a first and second coupling engageable with the first and second ends, respectively. The first and second couplings may be attached to first and second components of an additive manufacturing system, respectively. The couplings may be configured to permit rotation of the first and second ends of the cable carrier in response to movement of the second end and/or the second component in a direction transverse to a plane in which the cable carrier lies.

### RELATED APPLICATIONS

This application claims priority under 35 U.S.C. § 119 (e) to U.S. Provisional Application No. 63/509,907, filed Jun. 23, 2023, the content of which is incorporated by reference in its entirety for all purposes.

### FIELD

Inventive features relate to systems and methods for supporting cables in an additive manufacturing system.

### BACKGROUND

Additive manufacturing systems have been employed to generate parts from a variety of materials. In particular, laser powder bed fusion has been employed to melt and fuse powder material together by spreading the material on a build platform and fusing the material together through the use of lasers. Laser energy may be delivered from a plurality of laser energy sources through a plurality of cables to melt and fuse the powder material. The process of spreading material on a build platform and fusing the material together may be repeated until a part with desired characteristics is generated.

### SUMMARY

In some cases, additive manufacturing systems produce a printed part by delivering laser energy from a movable optics unit to a build surface to selectively fuse powder material on the build surface. A plurality of power and/or communication cables may be employed to deliver laser energy or electrical power to the moveable optics unit and/or provide communications between the movable optics unit and stationary components of the system. To limit or prevent damage and/or entanglement of the cables due to movement of the optics unit, it may be necessary to bundle or otherwise support the cables in a confined fashion. Pre-existing methods for supporting cables of this type may not provide sufficient rigidity to resist movement of the cables in certain directions while also ensuring that movement of the optics unit is not hindered and/or to provide the cables with any required minimum bend radius. For example, rapid movement and/or change in direction of an optics unit when scanning laser energy across a build surface may cause cables extending between movable and stationary components of the optics system to move in unwanted ways and/or apply stress to the cables. Thus, the inventors have appreciated that it may be desirable to provide a cable carrier assembly which is sufficiently rigid to properly support cables while also ensuring that other components of the additive manufacturing system (e.g., portions of the optics unit) can move in at least two directions.

According to some aspects of the disclosure, an assembly configured for use in supporting a plurality of power and/or communication cables in an additive manufacturing system is provided. The assembly may include an elongated cable carrier configured to support the plurality cables, where the cable carrier may have a first end and a second end. The assembly may also include a fixed component including a first coupling and a free component including a second coupling which may be engaged with the first and second ends of the cable carrier, respectively. The free component may be configured to move in an x-axis direction and a y-axis direction relative to the fixed component, and the first and second couplings may be configured to permit rotation of the first and second ends of the cable carrier relative to the fixed component and the free component, respectively, in response to the free component being moved in the y-axis direction.

According to some aspects of the disclosure, an assembly configured for use in supporting a plurality of power and/or communication cables in an additive manufacturing system is provided. The assembly may include an elongated cable carrier extending between first and second ends and configured to support the plurality of cables between the first and second ends. The cable carrier may be configured to permit free movement of the first and second ends relative to each other within a plane in which the cable carrier lies and may be configured to resist movement of the first and second ends relative to each other out of the plane. The assembly may also include a first coupling and a second coupling which may be engaged with the first and second ends of the cable carrier, respectively. The first coupling may be configured to permit rotation of the first end about a first axis that is parallel to the plane and the second coupling may be configured to permit rotation of the second end about a second axis that is parallel to the plane.

According to some aspects of the disclosure, a method of supporting a plurality of cables includes providing a cable carrier having first and second ends, where the cable carrier may be configured to permit free movement of the first and second ends relative to each other within a plane in which the cable carrier lies. The cable carrier may be configured to resist movement of the first and second ends relative to each other out of the plane. The method may further include moving the second end relative to the first end in a direction transverse to the plane and pivotably supporting the first end and the second end for rotation about parallel axes in response to movement of the second end in the direction transverse to the plane.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, like components may be represented by like numerals. For purposes of clarity, not every component may be labeled in every drawing. In the drawings:

FIG. 1 shows a schematic representation of an additive manufacturing system, according to some embodiments;

FIG. 2 shows a perspective view of an assembly configured for use in supporting cables of an additive manufacturing system, according to some embodiments;

FIG. 3 shows a side view of the assembly of FIG. 2;

FIG. 4 shows a front view of an assembly configured for use in supporting cables of an additive manufactured system, according to some embodiments;

FIG. 5 shows the assembly of FIG. 4, where a free end of the assembly has been moved along a transverse direction, according to some embodiments; and

FIG. 6 is a method of supporting a plurality of cables, according to some embodiments.

### DETAILED DESCRIPTION

Laser powder bed fusion allows for rapid generation of parts by melting and fusing powder material together through the use of lasers. The powder material may be spread onto a build surface, and an array of lasers may melt and fuse the powder material in a desired pattern to form a layer of a given part. The process of spreading material on a build platform and using the lasers to melt and fuse the material may be iteratively performed to yield a part with desired shape, size, material composition, or any other suitable characteristic. In some embodiments, a plurality of laser energy sources may deliver laser energy from a fixed portion of an optics assembly (e.g., including laser generators) to a movable portion of the optics assembly (e.g., including components configured to direct laser energy to the build surface) via a plurality of power and/or communication cables (e.g., fiberoptic cables). Such a configuration may reduce the mass and/or size of the movable portion, allowing the movable portion to be scanned or otherwise moved relative to the build surface in a rapid fashion. Rapid movement of the movable portion can reduce a time needed to form a printed part, but can apply stresses to various components of the optics assembly, including the cables that extend between the fixed and movable portions. For example, rapid movement of the movable portion can cause the cables to whip or otherwise be moved in an uncontrolled fashion, which may cause damage to the cables or other components that the cables may strike.

In some embodiments, the inventors have developed techniques to support power and/or communication cables that may be present in an additive manufacturing system, such as cables extending between fixed and movable portions of an optics assembly. The inventors have recognized that in some cases, by bundling or otherwise supporting the cables, the cables may remain organized and potential damage to the cables may be limited. The inventors have found that certain prior support techniques such as, for example, using cable carriers that allow cables to move in three-dimensions may not sufficiently protect and/or support the power and/or communication cables. For example, some prior cable carriers may undergo compression and expansion during movement, thus resulting in fatigue issues and potential damage to the cable carrier and/or cables. In addition, some prior cable carriers may inadvertently oscillate as a result of the rapid movement of components of an additive manufacturing system, which may result in the cable carrier and corresponding cables thrashing against and/or becoming entangled with other components of the additive manufacturing system. To address these issues, movement of the cable carriers may be partially or fully restricted along certain axes, e.g., by increasing the rigidity of the cable carrier along a given axis, but restricting movement of the cable carriers and cables may also restrict movement of components between which the cable carrier extends, such as the optics assembly and/or gantry. Thus, overly restricted support of cables may place excessive strain on the cables.

In addition to cable carrier configurations which permit movement of the cables in three-dimensions as described above, some prior cable support techniques employed two cable carriers arranged in series where each cable carrier permitted movement only within a singular plane. For example, a first cable carrier may support a first section of a set of cables and be arranged to allow movement of the cables in an X-Z plane and a second cable carrier may support a second section of the set of cables and be arranged to allow movement of the cables in a Y-Z plane. For example, such cable carriers may be connected between components that are movable relative to each other in only a single direction, such as between a fixed frame and a part of a first gantry that is movable in only a first direction relative to the frame, and between a part of the first gantry and a part of a second gantry that is movable only in a second direction (orthogonal to the first direction) relative to the first gantry part. The inventors have recognized that the use of such serially connected cable carriers may require a static section of the cables between a free end of the first cable carrier and a fixed end of the second cable carrier and/or may not allow for suitable control of the bend radius of the supported cables in certain sections. Certain power and/or communication cables, such as fiber optic cables, may have relatively large bend radius requirements (e.g., a bend radius 150 mm or more) and the use of two serially connected cable carriers may not allow for needed cable bend radius in some applications. Moreover, such serial cable carrier arrangements may introduce unwanted complexity and/or restrict system design.

In view of the above, the inventors have recognized that benefits may be realized by providing a cable carrier which may have sufficient rigidity to limit or prevent inadvertent oscillation or other movement of the cable carrier and corresponding cables while also permitting movement of the components between which the cables and cable carrier are connected (e.g., portions of an optics assembly and/or gantry) in at least two directions. In some embodiments, the inventors have found that such a configuration may be achieved by providing a cable carrier that permits relatively free movement within a plane in which the cable carrier lies but otherwise resists movement out of the plane and coupling both ends of a cable carrier via one or more couplings so as to permit rotation of the ends of the cable carrier. In particular, the couplings may be configured to allow the ends of the cable carrier to rotate in response to movement of a free component relative to a fixed component. Such an arrangement provides support of cables to prevent movement out of a plane of the cable carrier while also permitting relatively free movement of the cable carrier ends relative to each other in at least two orthogonal directions (e.g., along the x and y axes, and possible z axes), e.g., suitable for scanning laser energy.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

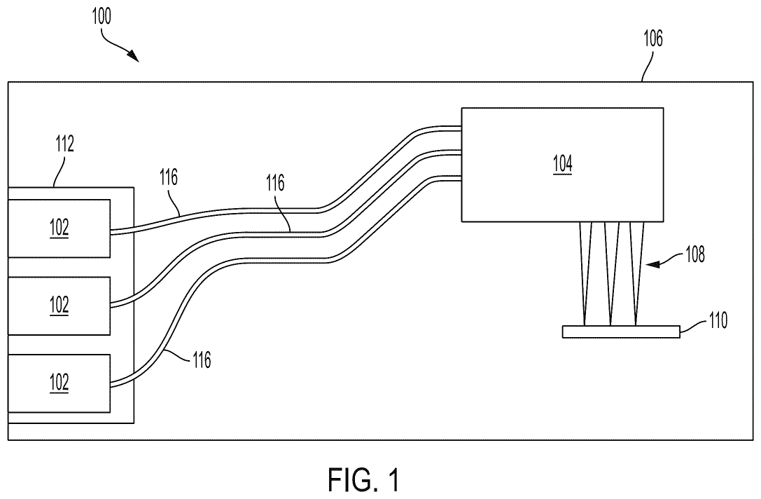

As disclosed herein, an additive manufacturing system may include a plurality of power and/or communication cables which, for example, may include optical fiber cables connecting laser energy sources to one or more portions of an optics assembly (e.g., an optics unit). FIG. 1 shows, according to some embodiments, a schematic representation of an additive manufacturing system 100, including a plurality of laser energy sources 102 that deliver laser energy to an optics unit 104 positioned within a machine enclosure 106. For example, the machine enclosure may define a build volume in which an additive manufacturing process may be carried out. In particular, the optics unit 104 may direct laser energy 108 towards a build surface 110 positioned within the machine enclosure to selectively fuse powder material on the build surface. The optics unit 104 may include a plurality of optics defining an optical path that may transform, shape, and/or otherwise direct laser energy onto the build surface. In some embodiments, the optics unit 104 may be movable to scan laser energy 108 across the build surface 110 during a manufacturing process. For example, the optics unit 104 may be associated with appropriate actuators, rails, motors, a gantry and/or any other appropriate structure capable of moving the optics unit 104 relative to the surface in at least two orthogonal directions. In some embodiments, the optics unit 104 may include galvomirrors or other appropriate components that are configured to scan the laser energy 108 across the build surface in concert with movement of the optics unit 104 relative to the build surface.

In some embodiments, a plurality of optical fibers or other cables 116 may extend between the plurality of laser energy sources 102 and the optics unit 104. In this manner, laser energy from each of the laser energy sources 102 can be delivered to the optics unit 104 such that laser energy 108 can be directed onto the build surface 110 during an additive manufacturing process. In some embodiments, the laser energy sources 102 may be contained within a fixed portion 112, e.g., which may be secured to the machine enclosure 106. Of course, other arrangements are contemplated as the disclosure is not so limited. For example, the laser energy sources 102 may be contained within the optics unit 104 and one or more cables 116 extending between the fixed portion 112 and the optics unit 104 may provide electrical power, communications or other functions. For example, one or more power cables may extend from the fixed portion 112 to the optics unit 104. Moreover, in some embodiments, at least a portion of the fixed portion 112 and/or the cables 116 may be positioned external to the machine enclosure 106 and extend through the enclosure to the optics unit 104. In any case, the inventors have appreciated that benefits may be realized by providing a cable carrier to support the cables 116 (e.g., including optical fibers, electrical wiring, etc.) and to control movement of the cables while also permitting movement of at least some of the other additive manufacturing system components (e.g., optics unit 104) in at least two directions.

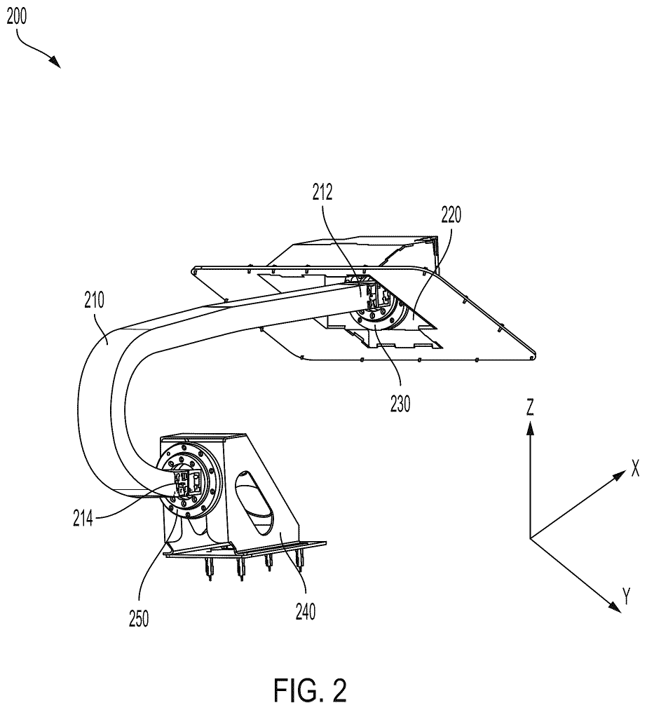

In some embodiments, a cable carrier may be an elongated cable carrier configured to support a plurality of cables, such as optical fiber and/or other cables extending between fixed and movable components of an optics assembly. The cable carrier may have first and second ends which may be configured to engage with first and second couplings, respectively, that are attached to respective first and second components. FIG. 2 shows an example arrangement of an assembly 200 configured for use in supporting a plurality of power and/or communications cables in an additive manufacturing system. The cable carrier 210 includes a first end 212 configured to engage a first coupling 230 and a second end 214 configured to engage a second coupling 250. The cable carrier 210 may be configured to permit relatively free movement of the first and second ends 212, 214 relative to each other within a plane in which the cable carrier 210 lies (e.g., a plane that extends through the cable carrier) but may be configured to resist movement of the first and second ends 212, 214 out of the plane. In FIG. 2, the first coupling 230 and the second coupling 250 may be attached to a first component 220 and a second component 240, respectively, and the first and second couplings 230, 250 may permit rotation of the first and second ends 212, 214 relative to the first and second components 220, 240, respectively. The first component 220 may be a fixed component and the second component 240 may be a free component that may be configured to move relative to the fixed component. For example, the second component 240 may be movable relative to the first component 220 in an x-axis direction oriented parallel to a plane in which the cable carrier lies, as well as being movable in a y-axis direction oriented perpendicular to the x-axis direction. In some cases, the second component 240 may be movable in the z-axis direction as well. In some embodiments, the fixed component may include a rigid frame on which the first coupling 230 is mounted as shown in FIG. 2, while the free component may include an optics unit 104 (not shown) configured to direct laser energy to melt powder material in an additive manufacturing process.

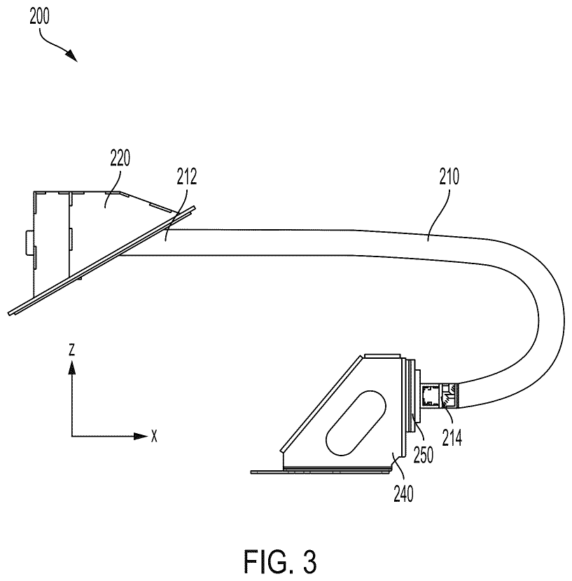

FIG. 3 shows a side view of the embodiment of FIG. 2. In FIG. 3, the cable carrier 210 is shown to be oriented such that a plane that passes through the cable carrier, or in which the cable carrier 210 lies, is in a plane of the drawing. In some embodiments, the plane may be an X-Z plane as shown in FIG. 3, and thus, the plane may be parallel to the x-axis direction and transverse to the y-axis direction. In some embodiments, the cable carrier 210 may be configured to permit free movement of the ends of the cable carrier 212, 214 within the plane while also being configured to resist movement of the ends 212, 214 relative to each other out of the plane. For example, the cable carrier 210 may permit the second component 240 to move freely relative to the first component 220 in the plane of FIG. 3, e.g., in the x- and/or z-direction, but may resist movement of the second component 240 out of the plane of FIG. 3 (unless the first component 220 moves correspondingly with the second component 240 out of the plane). As disclosed herein, the inventors have recognized benefits associated with providing sufficient rigidity to the cable carrier in at least some directions while also permitting movement of one or more components (e.g., second component 240) of an additive manufacturing system in at least two directions. For example, a cable carrier 210 that permits movement only in a single plane may help support cables, e.g., to prevent movement of portions of the cables out of the permitted plane of movement. This may help resist thrashing or other unwanted movement of the cables. According to some embodiments, this may be achieved by providing a cable carrier which is configured to permit movement of the ends 212, 214 only within a single plane, e.g., within the X-Z plane as described above, while coupling the ends 212, 214 to the first and second components 220, 240 so as to allow one of the components (e.g., a second component 240) to move in two orthogonal directions relative to the other component (e.g., the first component 220). This may be provided by employing couplings 230, 250 that permit rotation of the ends 212, 214 of the cable carrier 210 relative to the first and second components 220, 240. For example, while the cable carrier 210 may be resistant to movement of the ends relative to each other out of the X-Z plane as shown in FIG. 3, the couplings 230, 250 may permit rotation of the respective ends 212, 214 of the cable carrier 210 in response to movement of the second component 240 along the y-axis direction. The plane extending through the cable carrier 210 may thus be configured to move with the cable carrier following movement of the second component 240 in the y-axis direction. In addition, as can be seen in FIG. 3, the cable carrier 210 may extend along a non-linear path within the plane. While the cable carrier 210 is shown in FIG. 3 to be oriented relative to the X-Z plane, the cable carrier 210 may be oriented and configured to move within any suitable plane (e.g., X-Y plane or Y-Z plane).

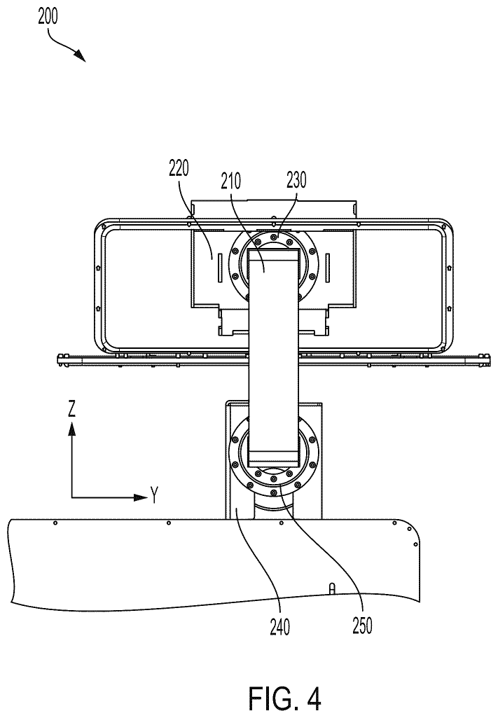

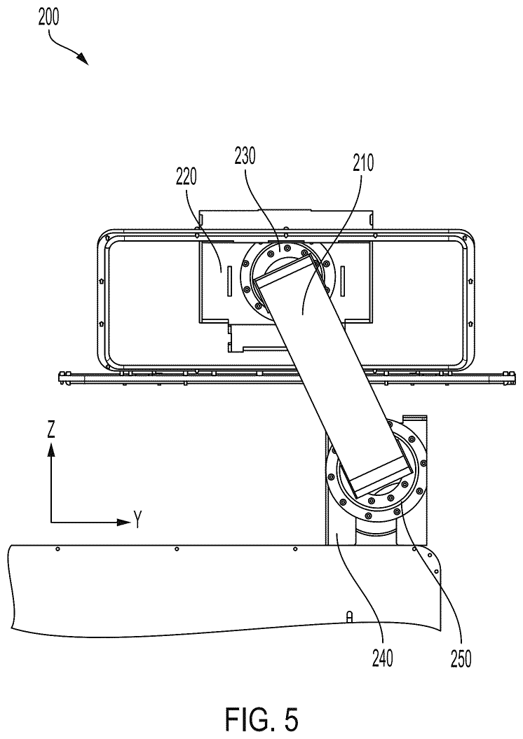

FIGS. 4 and 5 show an example arrangement of two different states of motion of a cable carrier and corresponding components of an additive manufacturing system 200, where the first state shown in FIG. 4 depicts a second component 240 in an initial state positioned immediately below a first component 220 with respect to the y-axis and where the second state shown in FIG. 5 depicts the second component 240 in a moved state where the second component 240 has been moved along the y-axis (to the right in FIG. 5). Specifically, in FIG. 4, the first and second components 220, 240 as well as cable carrier 210 may be initially oriented such that the X-Z plane passes through the cable carrier while the ends of the cable carrier are oriented in a similar position relative to the y-axis. In contrast, FIG. 5 shows that the couplings 230, 250 permit rotation of the first and second ends 212, 214 of the cable carrier 210, respectively, in response to the movement of the second component 240 along the y-axis. In particular, the first end 212 is rotated along a first axis and the second end 214 is rotated along a second axis, respectively, where each axis is parallel to the plane passing through the cable carrier 210 or parallel to the plane in which the cable carrier 210 lies. Accordingly, the plane passing through the cable carrier 210 (or in which the cable carrier lies) may pivot about an axis parallel to the x-axis in response to movement of the second component 240 and second coupling 250 along the y-axis direction. In some embodiments, the first and second couplings may be configured to permit movement of the components 220, 240 relative to one another in any suitable direction (e.g., along the x, y, and z-axis directions) as the disclosure is not so limited. Similarly, in some embodiments, the components of an additive manufacturing system (e.g., a free component containing an optics unit) may be configured to move in any of the x, y, and z-axis directions as the disclosure is not so limited.

The couplings may be of any suitable type, size, or any other suitable characteristic as the disclosure is not so limited. For example, the couplings may include rotary bearings such as crossed roller bearings and/or may include a flexible sleeve or other component that deforms (e.g., resiliently) to as to allow the needed rotation. In some embodiments, the couplings may have at least two portions. For example, the couplings may each have first and second portions, and the first portion of each coupling may be configured to attach to a component (e.g., a fixed or free component) while the second portion of each coupling may be configured to attach to a respective end of a cable carrier. In some such embodiments, the first and second portions of the couplings may be configured to rotate relative to each other to permit rotation of the ends of the cable carrier relative to the components of the additive manufacturing system. The couplings may also be of a suitable size to permit the cables to pass through a pathway formed between an opening in the couplings and a channel formed in a corresponding cable carrier. In some embodiments, the couplings may have an inner cross-sectional dimension (e.g., an inner diameter) greater than or equal to 1 inch, 2 inches, 3 inches, 4 inches, 5 inches, 6 inches, 7 inches, 8 inches, or any other suitable size as the disclosure is not so limited. In some embodiments, the size of the opening of the couplings may also be approximately the same size as a corresponding channel of a cable carrier such that the cable carrier and couplings define a pathway through which the cables may be supported within. In addition, while the couplings referenced herein may have a circular shape and in turn a circular opening through which the cables may pass, other suitable shapes are contemplated such as rectangular openings, trapezoidal openings, triangular openings, or any other suitable opening shape to accommodate passage of corresponding power and/or communication cables therethrough.

In some embodiments, the cable carrier may be constructed and arranged such that the cable carrier is hollow and has a defined internal volume (e.g., a channel extending therethrough). In some such embodiments, a plurality of cables in an additive manufacturing system may extend through and be supported within the internal volume of the cable carrier. Accordingly, an exterior of the cable carrier may be at least partially solid to enclose the internal volume of the cable carrier, which may ensure that the cables are confined within the internal volume of the cable carrier.

In some embodiments, the cable carrier may be formed of a plurality of links which may be connected to one another between first and second ends of the cable carrier. The plurality of links when engaged with one another may form a channel in which the plurality of cables may be supported. Such a cable carrier formed of links may be constructed and arranged to permit rotation of adjacent links relative to one another about a single axis while also resisting other relative movement of the plurality of links along other axes. For example, the links of the cable carrier may be engaged to one another in a way that adjacent links are movable relative to each other only about a single axis and/or within a single plane (e.g., the X-Z plane) while being resistant to other relative movement such as movement out of the plane. For example, U.S. Pat. Nos. 6,940,019 and 6,984,782 show arrangements of cable carriers that may be employed in some embodiments. U.S. Pat. Nos. 6,940,019 and 6,984,782 are incorporated herein by reference for disclosure of a cable carrier. While the use of links to form the cable carrier are described above, the cable carrier may also be formed in any suitable fashion as the disclosure is not so limited. For example, the exterior walls of a cable carrier may be at least partially solid while having a channel defined therethrough, and certain walls may have increased thickness relative to other walls to bias movement of the cable carrier in a certain direction. In such an example, the cable carrier may be biased to move along a direction with lesser thickness while the cable carrier may resist movement in the directions of greater thickness.

The cable carrier may be of any suitable material including, but not limited to plastic, steel, or a metal alloy. The cable carrier may also be constructed out of a combination of materials. For example, certain sides of the cable carrier may be constructed out of a flexible plastic while other sides of the cable carrier may be constructed out of a more rigid metal alloy. Such a configuration may result in movement being permitted for the cable carrier in certain directions (e.g., along the x-axis) while being resisted in other directions (e.g., along the y and z axes).

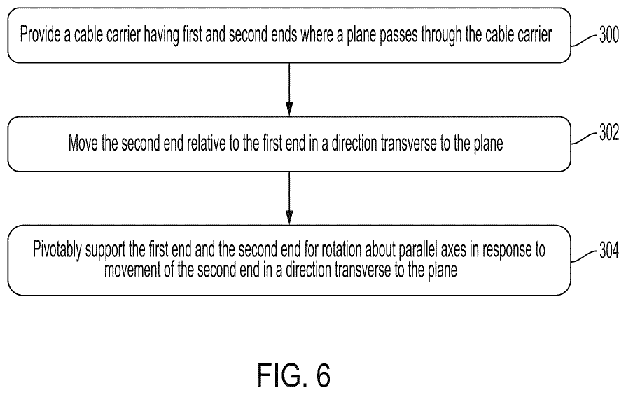

According to some aspects of the disclosure, the embodiments disclosed herein may be embodied as a method. An exemplary method of supporting a plurality of cables is shown in FIG. 6. In step 300, a cable carrier having first and second ends may be provided. The cable carrier may be configured to permit free movement of the first and second ends relative to each other within a plane in which the cable carrier lies while also being configured to resist movement of the first and second ends relative to each other out of the plane. The cable carrier may include a channel in which the plurality of cables may be supported.

In step 302, the second end may be moved relative to the first end in a direction transverse to the plane. In some embodiments, the first and second ends may be engaged with first and second components, respectively, of an additive manufacturing system. In some such embodiments, movement of the second component relative to the first component in a direction transverse to the plane may cause the movement of the second end relative to the first end in a direction transverse to the plane.

In step 304, the first and second ends may be pivotably supported for rotation about parallel axes in response to movement of the second end relative to the first end. The first and second ends may be pivotably supported via couplings which are engaged to the first and second ends of the cable carrier. The couplings may be configured to rotate in response to the movement of the second end of the cable carrier. The couplings may also be received by and attached to first and second components of the additive manufacturing system, respectively. In some embodiments, moving the second end relative to the first end includes moving an optics unit of an additive manufacturing system relative to a build surface. In some embodiments, the parallel axes may be parallel to the plane in which the cable carrier lies.

While an exemplary method has been provided herein in reference to FIG. 6, any embodiments of the disclosure may be embodied as a method as the disclosure is not so limited. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The inventors have realized that the embodiments disclosed herein may provide a variety of benefits when implemented for use in an additive manufacturing process. Such benefits may include providing robust cable support in at least two directions. In particular, the cables may be restricted such that the cables are only able to move in the same fashion as the cable carrier due to being confined within the carrier, and the movement of the cable carrier may be restricted such that the cable carrier can only move within a single plane (e.g., within the X-Z plane). In contrast, pre-existing cable carriers may be flexible such that the cables may move in any suitable direction, which may cause undesired oscillations of the cable carrier and cables. Thus, other benefits may include reducing inadvertent oscillations of the cable carrier and reducing fatigue associated with movement of the cable carrier (e.g., due to compression and/or expansion during movement). In addition, the components of an additive manufacturing system which may be secured to the cable carrier may be allowed to sufficiently move with an extra degree of freedom relative to the cable carrier. For example, a free end of the additive manufacturing system containing an optics unit may be configured to move in directions along the x and y axes while the cable carrier can only move along the x-axis. Moreover, the embodiments disclosed herein may provide the benefit of supporting cables with large bend radius requirements (e.g., fiber optic cables) while maintaining a compact and simplified cable carrier design. For example, a cable carrier may be configured to permit bending movement of supported cables to only a particular minimum bending radius, thereby providing cable movement in two orthogonal directions while suitably supporting the cables with a minimum bend radius.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An assembly configured for use in supporting a plurality of power and/or communication cables in an additive manufacturing system, the assembly comprising:
an elongated cable carrier configured to support the plurality of cables, the cable carrier having a first end and a second end;
a fixed component including a first coupling engaged with the first end of the cable carrier; and
a free component including a second coupling engaged the second end of the cable carrier;
wherein the free component is configured to move in an x-axis direction and a y-axis direction relative to the fixed component, and wherein the first and second couplings are configured to permit rotation of the first and second ends of the cable carrier relative to the fixed component and the free component, respectively, in response to the free component being moved in the y-axis direction.

2. The assembly of claim 1, wherein the first and second couplings each include a rotary bearing.

3. The assembly of claim 2, wherein the rotary bearings are crossed roller bearings.

3. The assembly of claim 1, wherein the free component includes an optics unit comprising a laser array configured to melt metal powder in an additive manufacturing process.

4. The assembly of claim 1, wherein the fixed component includes a rigid frame on which the first coupling is mounted.

5. The assembly of claim 1, wherein the cable carrier is configured to permit free movement of the first and second ends relative to each other within a plane in which the cable carrier lies and is configured to resist movement of the first and second ends relative to each other out of the plane.

6. The assembly of claim 5, wherein the cable carrier is oriented such that the plane is parallel to the x-axis direction and is transverse to the y-axis direction.

7. The assembly of claim 6, wherein the cable carrier is configured such that the plane moves with movement of the free component in the y-axis direction.

8. The assembly of claim 1, wherein the cable carrier includes a plurality of links coupled to each other between the first and second ends.

9. The assembly of claim 8, wherein adjacent ones of the plurality of links are coupled to permit only relative rotation of the adjacent ones of the plurality of links about a single axis, and to resist other relative movement of the adjacent ones of the plurality of links.

10. The assembly of claim 8, wherein the plurality of links define a channel in which the plurality of cables are supported, and wherein the first and second couplings each define a pathway that communicates with and is approximately the same size as the channel.

11. The assembly of claim 5, wherein the cable carrier extends along a non-linear path in the plane.

12. The assembly of claim 8, wherein links at the first and second ends of the cable carrier are fixed to the first and second couplings, respectively.

13. An assembly configured for use in supporting a plurality of power and/or communication cables in an additive manufacturing system, the assembly comprising:
an elongated cable carrier extending between first and second ends and configured to support the plurality of cables between the first and second ends, the cable carrier being configured to permit free movement of the first and second ends relative to each other within a plane in which the cable carrier lies and being configured to resist movement of the first and second ends relative to each other out of the plane;
a first coupling engaged with the first end of the cable carrier, the first coupling being configured to permit rotation of the first end about a first axis that is parallel to the plane; and
a second coupling engaged with the second end of the cable carrier, the second coupling being configured to permit rotation of the second end about a second axis that is parallel to the plane.

14. The assembly of claim 13, wherein the first and second couplings and the cable carrier are configured to permit movement of the second coupling relative to the first coupling along x, y, and z-axis directions.

15. The assembly of claim 14, wherein the first and second couplings and the cable carrier are configured such that the plane pivots about an axis parallel to the x-axis direction in response to movement of the second coupling in the y-axis direction.

16. The assembly of claim 14, wherein the first and second couplings and the cable carrier are configured such that the plane is parallel to the x-axis direction and is transverse to the y-axis direction.

17. The assembly of claim 13, wherein the cable carrier extends along a non-linear path in the plane.

18. The assembly of claim 13, wherein the cable carrier includes a plurality of links coupled to each other between the first and second ends.

19. The assembly of claim 18, wherein adjacent ones of the plurality of links are coupled to permit only relative rotation of the adjacent ones of the plurality of links about a single axis, and to resist other relative movement of the adjacent ones of the plurality of links.

20. The assembly of claim 18, wherein the plurality of links define a channel in which the plurality of cables are supported.

21. The assembly of claim 20, wherein the first and second couplings each define a pathway that communicates with and is approximately the same size as the channel.

22. The assembly of claim 18, wherein links at the first and second ends of the cable carrier are fixed to the first and second couplings, respectively.

23. The assembly of claim 13, wherein the first coupling is attached to a first component of an additive manufacturing system, and the second coupling is attached to a second component of the additive manufacturing system, the second component being movable relative to the first component.

24. The assembly of claim 23, wherein the second component includes an optics unit comprising a laser array configured to melt metal powder in an additive manufacturing process.

25. The assembly of claim 23, wherein the second component is movable relative to the first component in an x-axis direction that is parallel to the plane, and in a y-axis direction that is perpendicular to the x-axis direction.

26. The assembly of claim 23, wherein the first component includes a rigid frame on which the first coupling is mounted.

27. The assembly of claim 13, wherein the first and second couplings each include rotary bearings.

28. The assembly of claim 13, wherein the rotary bearings are crossed roller bearings.

29. A method of supporting a plurality of cables, the method comprising:
providing a cable carrier having first and second ends, the cable carrier configured to permit free movement of the first and second ends relative to each other within a plane in which the cable carrier lies and configured to resist movement of the first and second ends relative to each other out of the plane;
moving the second end relative to the first end in a direction transverse to the plane; and
pivotably supporting the first end and the second end for rotation about parallel axes in response to movement of the second end in the direction transverse to the plane.

30. The method of claim 29, further comprising engaging the first and second ends with first and second components, respectively, of an additive manufacturing system.

31. The method of claim 30, further comprising moving the second component relative to the first component in the direction transverse to the plane to cause the movement of the second end relative to the first end in the direction transverse to the plane.

32. The method of claim 31, wherein moving the second component relative to the first component in the direction transverse to the plane causes the first end and the second end to rotate about the parallel axes.

33. The method of claim 30, wherein the parallel axes are parallel to the plane.

34. The method of claim 29, further comprising supporting the plurality of cables in a channel of the cable carrier.

35. The method of claim 29, further comprising:
providing the first and second ends attached to first and second components, respectively, of an additive manufacturing system;
wherein moving the second end relative to the first end includes moving the second component relative to the first component in a direction transverse to the plane; and
wherein pivotably supporting the first end and the second end includes pivoting the first end and the second of the cable carrier relative to the first and second components, respectively, in response to movement of the second component in the direction transverse to the plane.

36. The method of claim 29, wherein moving the second end relative to the first end includes pivoting a link of the cable carrier relative to an adjacent link of the cable carrier.

37. The method of claim 29, wherein moving the second end relative to the first end includes moving an optics unit of an additive manufacturing system that is attached to the second end relative to a build surface.

38. The method of claim 37, wherein moving the optics unit includes providing laser energy via the plurality of cables to the optics unit.

39. The method of claim 38, further comprising:
directing the laser energy from the optics unit to a precursor material disposed on a build surface of the additive manufacturing system; and
selectively fusing the precursor material using the laser energy to form one or more parts on the build surface.

40. The method of claim 37, further comprising moving the optics unit in a direction parallel to the plane relative to the build surface.

41. The method of claim 37, wherein the first end is fixed relative to the build surface.

42. The method of claim 29, wherein pivotably supporting the first end and the second end includes pivoting a first portion of a first coupling that is attached to the first end relative to a second portion of the first coupling, and pivoting a first portion of a second coupling that is attached to the second end relative to a second portion of the second coupling in response to movement of the second end relative to the first end in the direction transverse to the plane.

43. The method of claim 29, wherein moving the second end relative to the first end includes pivoting the plane about one of the parallel axes.

44. A part manufactured using the method of claim 29.
